(19) United States
(12) Patent Application Publication
(10) Pub. No.: US 2020/0285799 A1
(43) Pub. Date: Sep. 10, 2020

(54) COMPUTER ARCHITECTURE FOR CUSTOMIZING THE CONTENT OF PUBLICATIONS AND MULTIMEDIA

(71) Applicant: TIMOTHY J YOUNG, NEW ORLEANS, LA (US)

(72) Inventor: TIMOTHY J YOUNG, NEW ORLEANS, LA (US)

(21) Appl. No.: 16/830,711

(22) Filed: Mar. 26, 2020

Related U.S. Application Data
(63) Continuation-in-part of application No. 15/784,712, filed on Oct. 16, 2017.
(60) Provisional application No. 62/827,247, filed on Apr. 1, 2019.

(51) Int. Cl. G06F 40/103; G06F 16/9535; G06F 40/166; G06T 13/40

(52) U.S. Cl. CPC G06F 40/103; G06T 13/40; G06F 40/166; G06F 16/9535

(57) ABSTRACT

The invention provides computer architecture for managing the publication of (1) ebook, (2) book, and (3) multimedia for a plurality of subscribers, which include parents, school administrators and teachers, caregivers, vocational educators, and students. In one embodiment, a user incorporates a child's phenotypic attributes into a computer system for creating a digital image of a character based on the attributes, which image may be used as the protagonist in a children's story. The invention further includes a subscription service for publications of story in the form of media. The invention also includes a content that may periodically change as a function of the child's growth and appearance, age, emotional and intellectual status, and optional subject matter, as determined by a subscriber.

### CROSS-REFERENCE TO RELATED APPLICATIONS

This nonprovisional patent application claims the priority benefit under 35 U.S.C. 120 for: U.S. provisional patent application Ser. No. 62/827,247, filed on Apr. 1, 2019; U.S. patent continuation-in-part application Ser. No. 15/784,712, filed Oct. 16, 2017; U.S. patent application Ser. No. 15/159,757, filed May 19, 2016; and U.S. provisional patent application Ser. No. 62/163,491, filed on May 19, 2015, the entire disclosures of which are hereby incorporated by reference.

### FIELD OF INVENTION

The present invention relates generally to computer architecture, software systems and networks for creating brand experiences for children through a custom-made media presented in the form of “My Day at ______x______” and experienced through a custom made child avatar, and inserted into digital and print media to allow forms of (1) ebook, (2) book, and (3) multimedia (collectively referred to hereinafter, as “media”).

### BACKGROUND

Many brands and businesses have developed ‘experiences’ for children, used to grow the business and engage with young children and their parents. For example, an amusement park has rides geared towards younger children, ‘Children’ museums exist in various cities across the country, and businesses offering ‘tours’ of their factories or stores to engage younger children.

These businesses often try to promote their children's experiences in advertising through brochures and radio and television marketing. But in each case, the experience is conveyed in very general terms and not unique to each child. Thus, such showcasing and marketing are often ineffective to truly promote that brand's child experience(s). What is not found are customizable stories that are personal to the patrons in a variety of commercial and entertainment enterprises. As such, these stories may be produced as media products with enterprise logos and reference to the institutions, such as schools, zoos, museums, attractions and parks, such as amusement or theme parks, and any other places that a child may attend. It may also be used in promotions, such as sponsorships by restaurants (e.g., McDonald's), and other merchants to attract customers.

Content used in current media do not contain serialized, changing scenarios that may be relocated into e-books, books, and multimedia such that may be supported by plotlines with serialized editions or changing content over time as a consequence of social and economic events (e.g., news and legal updates), so that content may be distributed according to a fixed schedule, life event, or interest occurring in an individual's life, education or vocation. For example, no known children's content, found in current media, allows parents to log into a computer system, establish a profile of their child based on age, demographics, or interests, and select life objectives, events, or topics on how to deal with issues that may apply to their child, and then have articles, blogs, or slide show presentations concerning such events or issues appear in a customized story of future content for that particular child. Such a system may be applied to other activities beyond a child learning experience, such as progressive training for a vocation, profession, or for learning a language.

Using the example of a child's learning experience, a parent must now search for current media, which might happen to include a life event, or issue within a storyline, relevant to their child's circumstance (age, domicile, educational objective), purchase the media, and read or watch it with their child, so as to then enrich, enhance, or facilitate learning or communication about the event or issue.

No known children's learning product exists that may also serve as a promotional material, such that, as the child develops, the content sought after is updated specifically to the child's interest, and that the main character or protagonist is an avatar that resembles phenotypic aspects of the child user's physical features and incorporates other elements of the child user's profile into one or more of the child's library of media so the library remains current and suitable to the child's level of maturity and subject matter interests.

The invention solves the above problem by creating the unique child avatar that is then placed inside a digital ‘experience’ of a particular institution or its brand, showcasing and the brand, as it relates to a child's experiences relative to the brand.

### SUMMARY OF THE INVENTION

The disclosure herein provides for a computer system architecture, a network, a method, and a software for creating a digital ‘experience’ of a particular institution or brand, showcasing the brand as it relates to a child's experiences relative to the brand, in the form of a media (ebook, book, or multimedia) in formats presentable as a 3-D computer graphics, a virtual reality presentation, or a 3-D printed product. The invention further assembles and creates, from a library of media content and a user specific database, such as by way of example and not limitation, the child avatar, using it's facial likeness, age, gender, religion, ethnicity, country of birth, country of residence, language, emotional and intellectual maturation factor, and parameters such as caregivers, their marital status or gender, social, local or economic influences, such as number, age and gender of siblings, and household demographics. The invention utilizes the forgoing and generates an output from the system to deliver the newly assembled media in formats presentable as the 3-D computer graphics, the virtual reality presentation, or the 3-D printed product and creates an active project, which thereafter is periodically updated to deliver additional new content in the form of the media.

An embodiment of the invention also includes the media utilized, by way of example and not limitation, in an amusement park, which may have rides geared towards younger children featured in the media. The customer, either the child or it's parents, then creates the child avatar, which is injected into the media, showing the child ‘virtually’ experiencing the brand's rides.

In another embodiment of the invention, the novel computer system architecture and the network automatically determines if a subject matter is relevant to an individual's profile, and assembles, in real-time, content-specific material, which may include one or a combination of one or more of originally created topic-specific content, templates, and media sources, whether in printed or electronic form, such as the e-books or the books containing stories, articles, reports, or visual arts, such as artwork, designs, plays, dramatizations, or music or other modes of expression, essential for the well-being and development of the child.

In yet another embodiment of the invention, the e-book can then be converted to print and kept as a keepsake. In this manner, the invention can be used to generate interest for new child customers or as a sellable product to be marketed to children who have already engaged with the brand and its child experience(s).

In one embodiment the invention can take the form of a repeatable series prefaced with the title “My Day At ______x______” wherein the “______x______” or other such titles, to represent a brand name or name of the child's experience. By way of example and not limitation, an amusement park may form the title to reflect “My Day At (name of amusement park)”; and sporting venues, form the title to reflect “My Day At (x=the name of the venue).” Unique to each product is the creation of the child avatar and insertion of said avatar into the brand's experience.

Another embodiment of the invention includes the media having one or more storage devices containing databases associated thereto, including the user-specific database; an active projects database; a library of content information database; a related content database; a web search engine, such as by way of example, a crawler to search and store new information into the related content database; a first processor for determining if the new information, based on data in the user-specific database updates the active projects database; a manager tool processor to load media content for updating the active projects database; a media processor having a plurality of tools to assemble, display the media; a second processor and related GUI interface for a user to create a 2-D digital image of the child avatar from: (a) one of a picture of the user's face, (b) a computer-generated representation of the user's face, (c) a menu of choices, wherein one or more character choices are based on features and attributes of the user; and an interface to automatically install the picture of the child avatar into a storyline, said storyline having one or more of a plot, scene, music, voiceover, one or more characters, and related vocalizations. In another embodiment of the invention, the invention allows for the creation of the computer-generated 2-D digital image of the child avatar in the story (or multiple characters), one of which resembles the user, thus allowing attributes of the user to be placed in the storyline in the form of a character image that over time may proceed to age and physically develop as the user matures. This may be accomplished through an online portal or system that allows for the user to select from numerous phenotypical attributes, such as face size, shape, hair color, texture, body shape, complexion, and other characteristics of the child, so as to create a personalized digital image that resembles the child.

In yet another embodiment of the invention, the character may be computer-generated through the use of facial recognition software or other software that image the child, or a photo of the child, and then proceeds to generate the character image or child avatar of the user.

In another embodiment of the invention, some articles of clothing of the story character may be customized by the user such that the clothing of one or more the characters may resemble the user attire.

Another embodiment of the invention relates to the ability for the aforementioned one or more customizable story characters to then be placed into the story, both as to artistic rendition and text through a media publishing or construction system and process. This embodiment of the invention requires that the publishing system allows for the insertion of the child avatar rather than simply allowing for the choice of a few pre-created characters with different features. The system herein may result in an exponentially large number of customizable characters and requires the inventive system and process to create a potentially unique character each time to then insert the character into the story art and text, rather than relying on traditional methods of pre-creating each variation of the allowed characters into the story art and text, and thus allowing the user to ‘select’ from the already created character variations.

In yet another embodiment of the invention, a ‘print on-demand’ system is created that allows for the uniquely created character to be inserted into the story art and text, creating a unique version of the story art and text as combined with that unique character. This ‘create on-demand’ may take the form of e-books, books, or multimedia, with the result being a unique end product of the media, containing the unique personalized character and the story art and text. Traditional models of ‘print on demand,’ in effect pre-creates multiple versions of story art and text for (1) the customizable nature of the character(s) and (2) the choice of storyline, art, text, music, and vocalizations.

In another embodiment of the invention, games are created which follow or resemble the story text and art and allow for the child user to engage with the same story text and art in a gaming or learning environment. Such ‘games’ may also include educational products, and may take the form of digital media and applications or print media.

In still another embodiment the invention will allow 3D virtual elements of (1) the computer system to includes 3D virtual elements of (1) a customizable feature of the character(s) and (2) a choice of one or more of a storyline, art, text, music, and vocalizations to appear in a projection of virtual images onto a wearer's visual field, such as the retina, thus conveying virtual animations and objects to provide an augmented sense of 3-D depth blurring the lines between the virtual and the real.

In another embodiment of the invention, a non-transitory computer-readable medium, such as a computer program, for execution by the processor comprising code for: (a) creating the media in formats presentable as the 3-D computer graphics, virtual reality presentations, or 3-D printed product; (b) storing the user-specific data in a first database; storing content related to the user specific data in a second database; (c) storing the library of content information in a third database; (c) loading a media application having a plurality of tools into one or more computers; (d) using the manager tool processor from the media application to load media content for creating the active projects into the active projects database from the user-specific data and the library of content information databases; (e) updating content of the median by searching additional resource information; (f) assembling the active projects into one or more of the media, interfacing a user application for creating one or more computer generated characters of the e-books, books, or multimedia, said characters based on attributes of the user, and automatically installing the one or more characters into the storyline, said storyline, optionally generated by the user or automatically, having one or more of a plot, scene, music, voiceover, one or more characters, and related vocalizations.

The non-transitory computer-readable medium may further include code for a document control module for generating separate parts of a document as well as further code to edit the active project, wherein the edit relates to one or more of periodic changes in the user's maturity, age, physical growth, emotional status, achievements such as educational, sports, civic accomplishments, work status and accomplishments including occupational goals, vocational achievements and goals.

### BRIEF DESCRIPTION OF THE DRAWINGS

FIG. 1 is a block diagram of a computer architecture and system for a subscription service, which delivers print or electronic content on a regular basis to a subscriber, based upon information regarding the individual consumer, in accordance with an embodiment of the present invention.

FIG. 2 is a flowchart illustrating various steps in a method of computer-based creation and subscription service, for print or electronic content for an individual on a regular basis, based upon profiles and objectives regarding the individual, in accordance with an embodiment of the present invention.

FIG. 3 is a flowchart illustrating various steps in a method of computer-based creation and subscription service, for print or electronic content for an individual on a regular basis, based upon profiles and objectives regarding the individual, in accordance with an embodiment of the present invention.

FIG. 4 is a chart illustrating three categories of items used to form profiles, and other database records, to determine the type of content that a library assembles, and stores for inclusion into the media, in accordance with an embodiment of the present invention.

FIG. 5 is a block diagram of a computer architecture and system for accessing Internet information based on relevancy to information resident in a profile of an individual, an based on the relevancy, updating of the media or producing a 3-D product, in accordance an embodiment of the present invention.

FIG. 6 is a block diagram of a computer architecture and system, in accordance an embodiment of the present invention.

FIG. 7 is an illustration of a computer screen, wherein the computer system contains an e-book, in accordance an embodiment of the present invention.

FIG. 8 is an illustration of a printed book cover, in accordance an embodiment of the present invention.

### DETAILED DESCRIPTION OF THE INVENTION

In the figures to be discussed, the blocks and arrows represent architectural, system features, functions and processes according to embodiments of the invention, which may be implemented as computers, networks of computers, application-specific processors, computer-executable code, and/or electrical circuits and associated wires or data buses, which transport electrical signals. Alternatively, one or more associated arrows may represent communication (e.g., data flow) between networks, databases and software routines, particularly when the present method or apparatus of the present invention is implemented as a digital process.

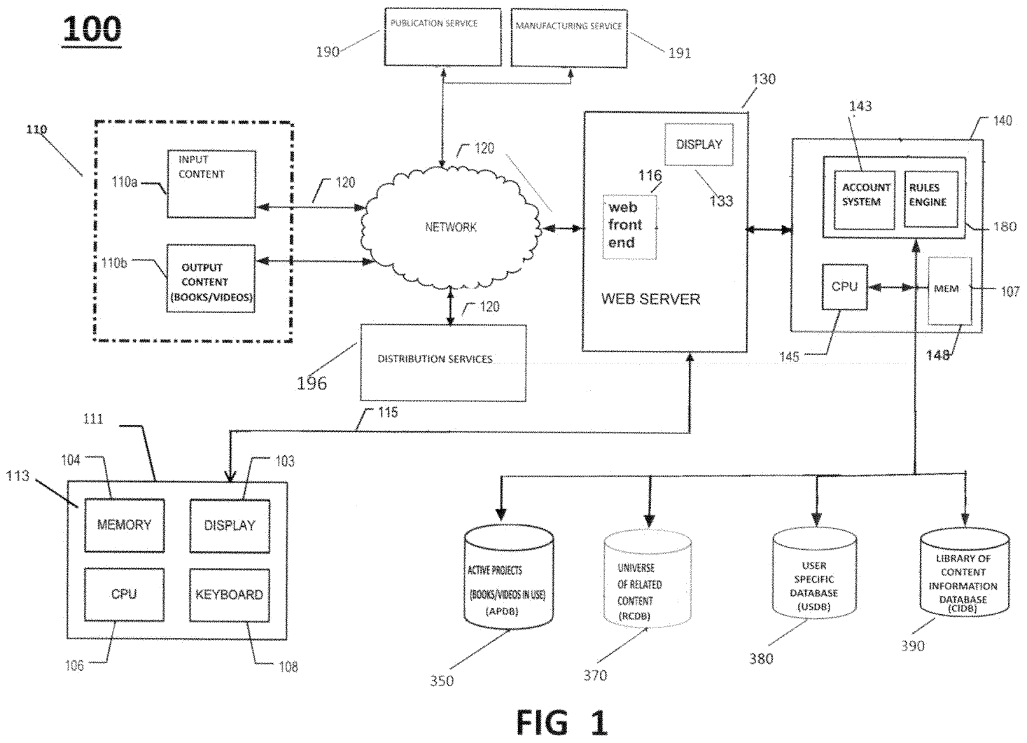

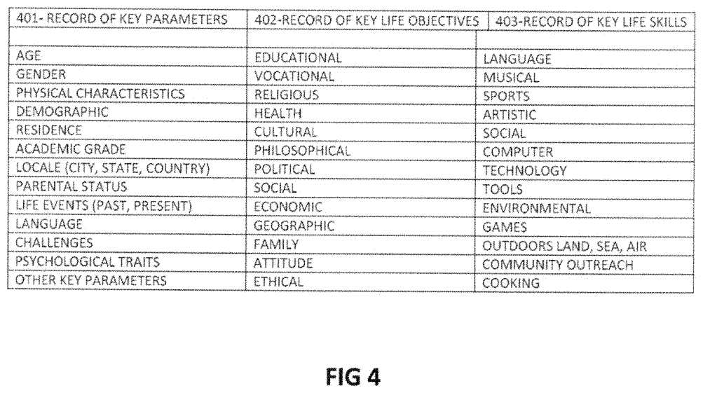

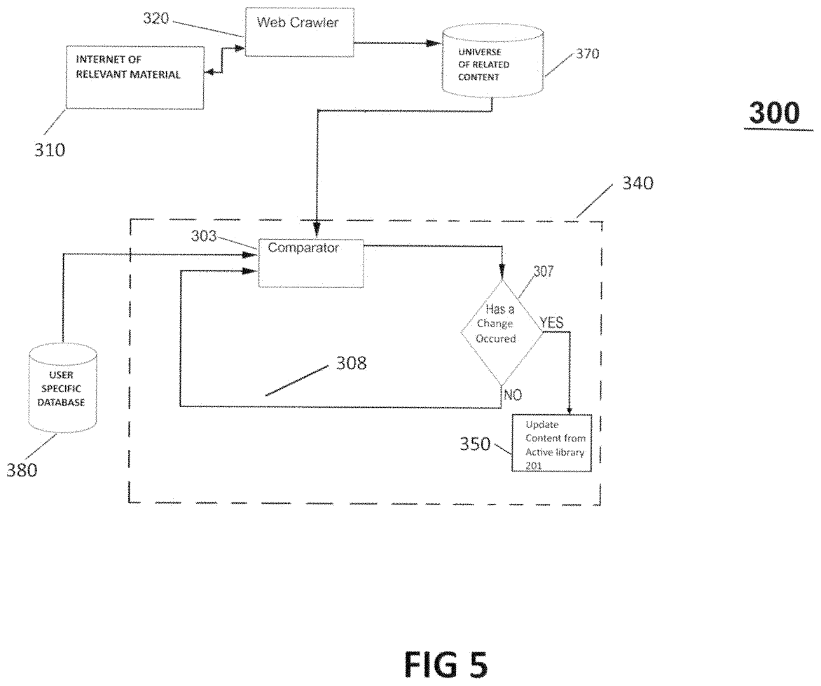

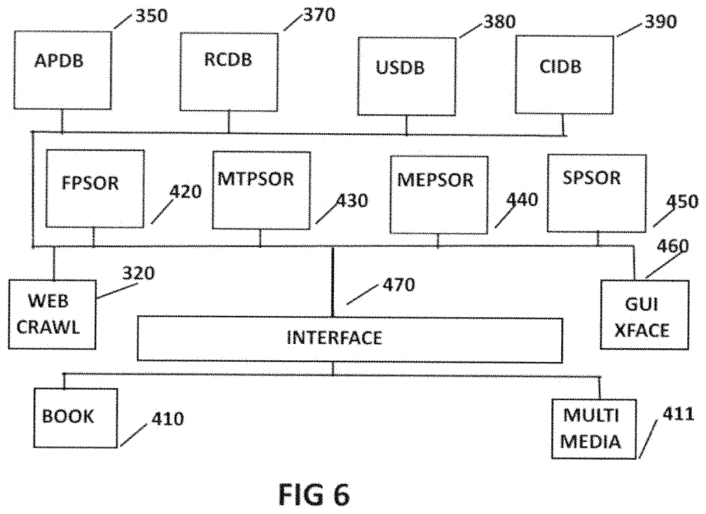

As indicated above and referring to FIG. 1, the invention relates a computer system for creating one of a book, e-book, multimedia presentation or a 3-D printed product, having one or more storage devices containing databases associated thereto, including a user specific database 380; an active projects database 350; a library of content information database 390; a related universe of related content database 370; a web crawler search engine (FIG. 5, 320) to search and store new information into the universe of related content database 370; a first processor (FIG. 5, 340) for determining if the new information, based on data in the user specific database 380, updates the active projects database 350; a manager tool processor (see, FIG. 6, 430) to load media content, for updating the active projects database; a media processor (see, FIG. 6, 440), having a plurality of tools to assemble and display the book, e-book, or multimedia presentation, 3-D printed product; a second processor (see, FIG. 6, 450), and related GUI interface for a user to create a 2-D digital image or avatar of a childlike character from: optionally from: (a) one of a photograph of the user's face, or (b) a computer generated representation of the user's face based on a menu of choices, wherein one or more character choices are based on features and attributes of the user (FIG. 4); and an interface (see, FIG. 6, 470), to automatically install the image or avatar of the childlike character into a storyline, having one or more of a plot, scene, theme, music, voiceover, one or more characters, and related vocalizations: optionally (1) authored by the user, or (2) automatically computer generated, using a program that processes key words (e.g., brand or particular experience, such as a visit to a zoo, sporting event or museum) to create the storyline.

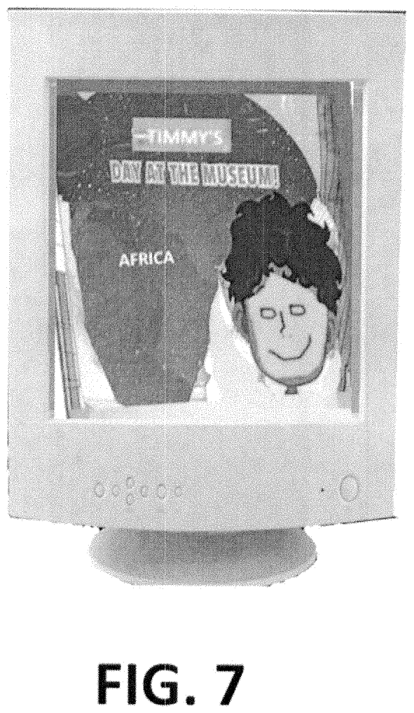

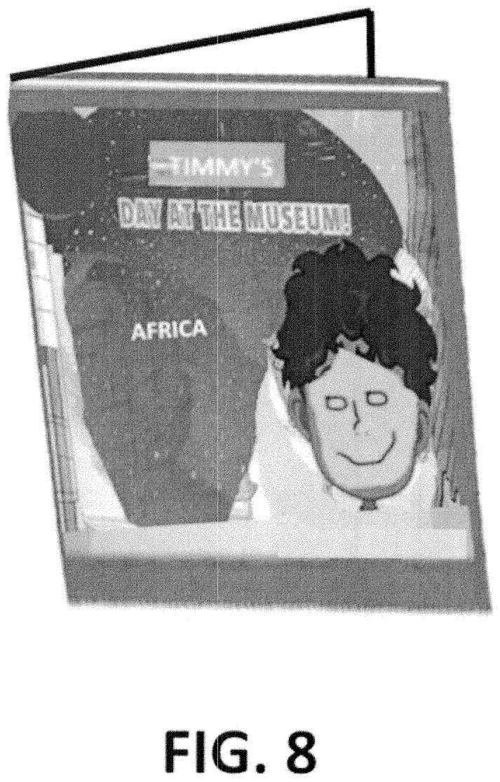

In one embodiment of the invention, the computer architecture and system described in FIG. 1, facilitates the creation of a work, (e.g., e-books, books, or multimedia in formats presentable as the 3-D computer graphics, virtual reality presentations, or 3-D printed product) (collectively, the “Work”). FIG. 7 is an illustration of the Work created in the image of a computer system screen or in the form of a computer cover, in accordance an embodiment of the present invention. FIG. 8 is an illustration of the Work as a printed book cover, in accordance an embodiment of the present invention. Such titles may make reference to schools, zoos, museums, parks, attractions, such as amusement parks or theme parks, and any places that a child may attend. It may also be use in promotions, such as sponsored by restaurants (e.g., McDonald's) and other merchants that may want to attract customers.

The Work is dependent on an individual's preferences, and development, such as by way of example, factors list in in FIG. 4. Referring to FIG. 1, a computer system includes: one or more computers as depicted by reference to 110, 111, 130, and 140, and one or more storage devices containing databases associated thereto, including a user-specific database 380; an active projects database 350; a library of content information database 390; a related content database 370; a search engine, such as web crawler (FIG. 5) by way of example and not limitation, to search and store new information into the related content database 370; a processor (FIG. 5, 340) for determining if the new information, based on data in the user-specific database 380, must update the active projects database 350; a manager tool processor 430 (see, FIG. 6), generally located in a processor 140 (FIG. 1), to load media content for creating from the updated active projects database 350; one or more of the media; the media application, generally located in the processor 140, having a plurality of tools for the one or more computers to assemble, display and distribute one of the media, wherein the user interface (see, FIG. 6) allows for the user to create a likeness of the user from a photograph of the user, the computer-generated representation of the user's face, or the menu of choices of one or more computer-generated characters, which in all instances, the character inserted in the media is based on features and attributes of the user, and wherein the one or more characters inserted in the media are part of the storyline, having one or more of the plot, scene, music, voiceover, and character vocalization. In yet another embodiment of the invention, the character for the storyline may be computer-generated through the use of facial recognition software or utilizes a photo of the child, and then proceeds to generate the digital image or avatar of the user, for incorporation into the storyline.

The 3-D printing feature of the invention refers to additive manufacturing, the process used to create a three-dimensional object, in which layers of material are formed under computer control to create the object. Objects can be of almost any shape or geometry and are produced using digital model data from a 3D model or another electronic data source such as an Additive Manufacturing File (AMF) file. STL is one of the most common file types that 3-D printers can read. Thus, unlike material removed from a stock in the conventional machining process, 3D printing builds a three-dimensional object from computer-aided design (CAD) model or AMF file by successively adding material layer by layer. As such, the invention includes software and computer processes capable of converting the active projects files or library of information content, insofar as specific elements are concerned, such as an image or avatar of the child user or other images, such as animal shapes, into 3-D products.

The virtual reality feature of the invention allows 2-D or 3D virtual elements of (1) the customizable nature of the character(s) and (2) the choice of storyline, art, text, music, and vocalizations to “appear” in real life by allowing a projection of virtual images onto a wearer's visual field, such as the retina, utilizing a virtual reality system, such as commercially available or stereoscopic lens, thus conveying virtual animations and objects to provide an augmented sense of 3-D depth blurring the lines between the virtual and the real.

A system 100 allows a subscriber 110 to log into a terminal 110a and input content, which may consist of web pages, via URL addresses, or other content, and upload photos and other writings, as well as the key in parameters, objectives, and skills, as illustrated in FIG. 4. An input uploads and keys-in information to be used by the system to create, edit, and modify the media. A terminal 110b provides a private secure electronic means to view any content, based on the user or the subscriber 110 inputs and to select other options, such as requests for the delivery of a publication or multimedia presentation.

The user or subscriber in using the terminal 110a employs various graphical user interfaces (GUI) having thereon menu options to alter the content of a publication or multimedia presentation resident in the content provider's system of active products 350, i.e., the actual content of the media at any point in time, for which the subscriber has been permitted access, based on various subscription plans. Alternatively, the subscriber using the terminal 110a employs various GUIs having therein menu options to assemble new content from the universe of the related content 370 and the library of content 390. Altered content and newly assembled content are stored in the active project database 350 and accessible on demand. Utilizing a web server 130, with a display 133 and a front end 116 (e.g., router, modem) connected to a network, such as the Internet or an intranet, the content provider, such as a publisher, logs into a terminal 111, to administrate and to view all data, including a library of content, templates, and reference materials in the database 390 and the active projects in database 350. In another embodiment of the invention, the subscriber active products database 350 and the library of content data 390 is updated automatically via algorithms and rules, as more fully described with reference to FIG. 5, below.

The library of content 390 comprises the material culled from a network of resources, such as libraries at several virtual or actual locations, templates, genre, categories, such as bibliographic items, from any information entity (e.g., e-book, books, computer files, graphics, cartographic materials, multimedia files, audio files, etc.) that is considered library material (e.g., a single novel or story in an anthology), or a group of library materials (e.g., a trilogy), or linked from a catalog (e.g., a webpage), as far as it is relevant to the user's particular catalog, upon which the e-book, books, audio, and multimedia presentations, will be created, edited, updated, assembled and distributed. In one embodiment, the overall content provider, as publisher logs into the terminal 111, to push publisher content to one or more of the universe of the related content 370 and the library of content database 390.

By way of illustration, the story of The Three Bears, may be resident in the library of content 390, and include a variable, such as age, where the age and behavior of the youngest bear can be altered in accordance with a rules engine, 180, that takes into account the desires, parameters and the user's objectives as illustrated, by way of example, in FIG. 4. Thus for a child of four years old, the youngest bear might seem itself as young and as large as the child. As the child grows the picture of the bear can illustrate a larger bear, and its speech pattern might change as well to reflect that the bear is maturing.

Further, using the input device 110a, the system allows each logged-in subscriber to input data, as illustrated in FIG. 4, such as gender, age, optional factors related to a child's emotional and intellectual status, other relevant demographic data, current events, and optionally current subject matter. The system 100 also allows for the automatic computer generation of the publication or multimedia presentation by utilizing a publication service 190, for electronically pulling in certain data and factors relevant thereto, all available within the computer system, including, but not limited to, the subscriber's selected life events or issues, which then are included in future content, such that a parent, teacher, home school education provider, or child care provider may address educational, social, cultural, and personal events or issues deemed relevant to the ultimate user, i.e., reader or viewer, such as a pre-school child, student, or employee.

System 100 further allows for the uploading of all required documentation, including documentation to the output content 110b terminal of each publication or multimedia presentation. The output of content allows for the optional printing of publications, including e-book display, at the subscriber's site on the terminal 110. In the event that the subscriber using the terminal 110 does not desire to receive the publications or multimedia via the output content terminal 110b, then the publication services delivers the content to a distribution services 196 for hard copy printing or multimedia recording and distributes the content to the subscriber via mail-type service, US Postal, UPS, etc.

In general, FIG. 1, the system 100, includes an innovative network for achieving the objectives of the invention, such as a local area network (LAN) of terminals or workstations, database file servers, input devices (such as keyboards and document scanners) and output devices configured by software (processor-executable code or application-specific processors (hardware, firmware, and/or combinations thereof), for accumulating, processing, administering, creating, printing, and distributing the publication or multimedia.

The system 100 provides for calculating the publication or multimedia costs, preparing invoices and sending out bills on a periodic basis, and additionally provides for electronic data transfer pertaining to administrative data, and billing via an account system 143, which further allows for receipt of payment for the service by subscribers. The system via the accounting system 143 also allows for the electronic dissemination of terms and conditions, and receipt of the execution of contractual documents, for the underlying commercial transaction, ordering or requesting quotes for a specified publication or multimedia.

The features of system 100 may be implemented in a system of computer peripherals that communicatively coupled to various types of networks, such as a wide area networks and the global interconnection of computers over private networks, and computer networks commonly referred to as a network 120. If the network 120 is an intranet, then the intranet connects to the World Wide Web, such as the Internet. Otherwise, the network 120 represents the Internet in this disclosure. Such a network may typically include one or more microprocessor based computing devices, such as application specific processors such as computer (PC) workstations, smartphones and servers.

“Computer,” as referred to herein, generally refers to any computing device that includes a processor. “Processor,” as used herein, refers generally to a computing device including a central processing unit (CPU), such as a CPU 145. A CPU generally includes an arithmetic logic unit (ALU), which performs arithmetic and logical operations, and a control unit, which extracts instructions (e.g., software, programs or code) from memory and decodes and executes them, calling on the ALU when necessary. “Memory”, as used herein, refers to one or more devices capable of storing data, such as in the form of chips, tapes, disks or drives. Memory, such as a memory 148 may take the form of one or more media drives, random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including a processor or a computer.

The term “server,” as used herein, generally refers to a computer or device communicatively coupled to a network, such as the network 120 that manages network resources. For example, a file server is a computer and storage device dedicated to storing files, while a database server is a computer system that processes database queries. A server may refer to a discrete computing device, or may refer to the program that is managing resources rather than an entire computer.

In FIG. 1, each of the elements illustrated are implemented as discrete hardware elements. As would be appreciated, the inventive system described herein utilizes terminals for inputting publication or multimedia data and distributing the publication or multimedia, such as the terminals 110a and 110b, the servers 130 and 140, and the associated databases 350, 370, 380, 390 as may be embodied in this special purpose computing system, utilizing dedicated logic circuits, integrated circuits, Programmable Array Logic (PAL), Application Specific Integrated Circuits (ASIC), each of which provide outputs in responses, specific to the application herein described.

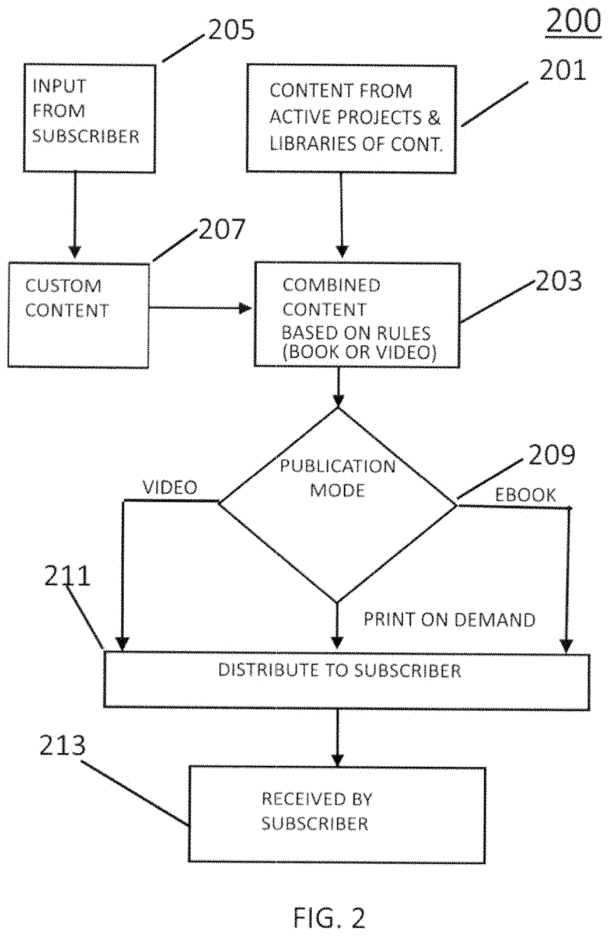

In FIG. 1, the system 100 and a processor 106 and 140 carry out the steps of a process 200 shown in FIG. 2, within each processor, as embodied in hardware, having special-purpose instructions therein or utilizing a computer having a computer-readable medium, for the acquisition of particular subject matter in accordance with the profile (e.g., FIG. 4) of the user and input from the subscriber that desires to acquire special editions of publications or multimedia based on certain life events or issues, included in content, typically in the context of educational, social, cultural, and personal events or issues relevant to the ultimate reader or viewer.

The Internet connection 120 connects various subsystems, such as to the user or subscriber terminal 110, the distribution services 196, the publication services 190, a manufacturing service 191, and to the central site web server 130. The server 140 uses software for loading a media application having a plurality of tools into the one or more computers, such as the server 140 and terminal 111, which includes a memory 113, a display 103, and optionally a keyboard 108; and using the manager tool processor (see, FIG. 6, 430), from the media application, loads various media content related to active products into the database 350; obtaining input from the user via the terminal device 110 information, as it relates to the individual for whom the e-book, book, multimedia presentation in formats presentable as 3-D computer graphics, virtual reality presentations, or a 3-D printed product will benefit; determine whether new editions of the product are required modify the current active product, and if so, proceed to incorporate the changes, and to assemble the final product files; and to manage the distribution and billing of the services to the subscriber. As indicated, certain actions of the server 140 are controlled in part through the administrative terminal 111.

A rules engine 180 allows for the customization of a particular type of publication or multimedia, by integrating the subscriber's input, such as input from the records and data found in FIG. 4, e.g., the library of content database 390, the universe of related content database 370, the user-specific database 380, the subscriber input from terminal 110, and the publisher input from terminal 111, and when relevant other data existing in the records of the active products database 350. Based upon certain algorithms, the rule engine 180, periodically, automatically weaves in new content into existing active products (e.g., publication or multimedia), so that these changes and ongoing changes, made by the user or subscriber using the device 110, seamlessly integrate into the current edition of the final product. The analogy is that it inserts new pages or deletes old pages of an e-book, book, resident as an active product, as determined by the relevance of the new information and the profile of the user. Once the publication or multimedia is assembled, that is the content is fully joined, the finished product is transmitted through the network 120, to the subscriber 110 or to the distribution service 196 for delivery.

Communications represented by a line 115, may be of a wired and/or wireless type to provide interconnectivity between the administrative terminal 111, the active product database 350 and one or more resources connected via the Internet 120. Alternatively, the administrative terminal 111 may be connected to the webserver 130 via the Internet 120. Communications to the Internet may in-turn be established by a wide area network, a metropolitan area network, a local area network, a terrestrial broadcast system, a cable network, a satellite network, a wireless network, or a telephone network, as well as portions or combinations of these and other types of networks (all herein referred to variously as a network and/or the Internet). The system 100 can function from encryption or non-encryption enabled computer software equipped with a browser, such as by way of example and not limitation, MICROSOFT® INTERNET EXPLORER browser for the World Wide Web by Microsoft Corp. of Redmond, Wash.; or MOZILLA FIREFOX® by the Mozilla Corporation of Mountain View Calif., or with IPod®, IPad® (each registered trademarks of APPLE, Inc. of Cupertino, Calif.), and Smartphone devices that utilize browsers such as, but not limited to those commonly known as Safari, Nokia, Android, and Samsung.

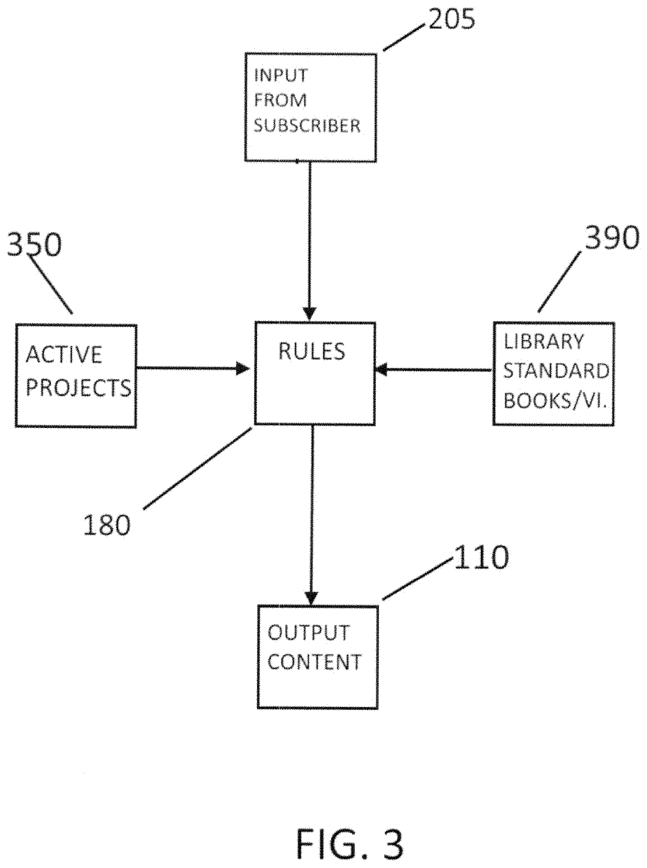

FIG. 2, FIG. 3 represent one embodiment of the method 200 for creating a customized version of a e-book, book or multimedia that includes the step of accessing a content 201 (i.e., data and information from the active projects database 350, the universe of related content database 370, the user-specific database 380, and the library of content 390) and using the rules 180, to combine the foregoing data. In a step 203, the aforementioned from the step 201 is combined with a subscriber 205 generated data using the terminal 110. The combined content 203 is forwarded to a publication mode 209, which, based on further input from the subscriber, determines the mode of publication, such as by way of example, an eBook or print-on-demand. In a step 211, the media is distributed to the subscriber to be received by a 213 by the subscriber for the intended purpose, e.g., reading or viewing by an individual such as a child.

As shown in FIG. 2B, one non-limiting embodiment includes a second processor and graphical user interface (GUI) for the user to create the 2-D picture of a childlike character from the first menu of choices. The character is based on attributes of the user. Once the character is selected, it is automatically installed into a central character of a pre-existing storyline, wherein the storyline contains one or more of a plot, scene, music, voiceover, and character vocalization. In a playback mode, such as an e-book, the projection of the character in the storyline follows the story from beginning to end.

In one embodiment, a database includes digital music, voiceover, and character vocalization, in various formats, such as MP4, which are integrated appropriately, by design into the storyline. Thus the character in the story contains a soundtrack, uploaded in during a construction phase of the creation of the e-book or multimedia presentation, that allows the user to not only read the story but alternatively to allow the user to hear an audio version of the story, for example as if the characters in the story were speaking. In another embodiment, an uploaded voiceover reads the story as it advances. Methods of synchronizing the audio portion and the visual (video or e-book representation) of the story are well-known to those skilled in the art of digital production.

The computer system also generates a 2-D character based on the user's age and phenotypical characteristics, such as one or more of a face size, shape, hair color, texture, body shape, complexion, to create a digital image or avatar of a childlike character. These characteristics form a subset of the childlike character, which is stored in the image database and later accessed via a GUI menu. In some instances there is option, to upload, during a construction phase of the creation of the e-book or multimedia presentation in formats presentable as 3-D computer graphics, virtual reality presentations, or a 3-D printed product, facial features, such as face size, shape, hair color, and complexion. In an alternative mode of operation, a detector utilizing one of a camera or video capture device, captures a digital image of the face of the user's facial characteristics and stores an image of the face into an image database. Alternatively, the digital image or avatar may be created via a photo of the user.

The characteristics such as hair color, texture, and style as stored in the computer database, or as detected by the computer system and stored, such also created and stored for incorporation of the protagonist in the storyline.

Similarly a database of one or more articles of clothing of the one or more characters is uploaded, during a construction phase of the creation of the e-book or multimedia presentation, and later selected by the user for incorporation into the storyline, utilizing the second menu of choices. The user has the choice through a GUI menu to associate different articles of clothing to different characters in the e-book or presentation.

In an alternate embodiment, third parties may submit or may be invited to submit content for inclusion in one or more of the universe of related content 370 and the library of content database 390. A third party submitter logs on to the server 130 (FIG. 1). Prior to acceptance of any submission, the submitter of content electronically accepts the publisher's terms of submission, which may include the grant of all rights, title, and interest in and to the submitted content, or the grant of such other rights as the publisher requires prior to acceptance. Content submitted by third parties is processed via algorithms and rules, as may be resident in the rules engine 180, and processed via the CPU 145, based on publisher controlled parameters to determine and verify among other things, that the content does not contain damaging, disabling, or unsuitable code or content, including but not limited to malware, viruses, or other hidden or malicious code or content, pornography, and vulgarity. Content that meets the scan parameters is then stored in the content database 390. The publisher logs into the terminal 111, to determine utilizing, among other things, algorithms and rules, the suitability of material stored in the content database 390.

In one non-limiting embodiment, the content for the media is created or built out one time, i.e., a first edition, wherein the subscriber experience (i.e., variable), as stored in user-specific database 380, is accounted for, in drawing upon the library content 390, in assembling the content of the active projects 350, i.e., the first edition of the book or multimedia product. If a life change event occurs, such as a sibling birth, marriage, or even death of close one, as keyed in by the reference 110a, or as reflected in the user specific database 380, then the new information causes the process to takes an alternate path or new branch, which deals with the particular event, in assembling a derivative publication, or next and subsequent editions, by analogy to a conventional book or multimedia product. Note that new information, subjects or material of the new content will exist in the library of content database 390, or the universe of related content database 370, which may represent content analogous to a movie, or story having alternate endings, one of a multiple plotlines. The update is inserted, to augment or replace, the revised active projects 350 e-book, book or multimedia, according to the subscriber's dictates or changed status, i.e., how his/her personal profile changes. Note, that in substantive respects, the main story of a particular active project may be similar to the story of other subscribers. Essentially, if two people were to select the same life events, including the permanent ones, they would each get the same content for that revision during the period (e.g., monthly).

In another embodiment of the invention, discussion questions and topics are added to the active product content such that, by way of example, at the end of a defined period, (e.g., monthly) a parent can discuss and answer such questions with the child user. They may take the form of open ended questions such as “What would you have done if you were [the main character] faced with the challenge he faced?” When the media content is electronically delivered to the user or subscriber, the questions may be answered online and then collected and shared among other subscribers to the service, such that by way of example, a parent and child can read and discuss other answers or comments to the questions or discussion points for that period (e.g., month). In one embodiment of the invention, the parent may elect to subscribe to such discussion questions or topics or elect not to, and this would control whether such questions appeared at the end of the periodic e-book or multimedia content. The election to subscribe would be made part of the records stored in the library of content, to be added to the active products, would append specific fields to the e-book or multimedia product and allow the user to thereby interact with the product.

In one non limiting embodiment, the system 100, under the process embodied in FIG. 2, the method 200, utilizes the terminal 111 configured to communicate with the server 140 for active product content creation, publication, and distribution that optionally Works in conjunction with the publication services 190, the manufacturing services 191, or the distribution services 196. The various software required for publication assembly, publication printing, 3-D printing, resides in a memory 104, and works with the active product content database 350. Application software for publication, such as printing conventional books, or displaying e-books, or the creation of a 3-D printed product, is generally known to those of ordinary skill in the art of electronic printing. A utility software resident in the memory 104 and a memory 107, a system's design choice, permits the web server 130, to receive from the an administrative terminal 111 publication or multimedia instructions related to the creation and distribution of active products stored in the database 350.

The method illustrated in FIG. 2 and FIG. 3 may be implemented in a non-transitory computer-readable medium containing instructions for execution by a processor, the instructions including accessing standard content 201 (i.e., data and information from the active projects 350 and the databases 390, 370, 380, and using the rules 180 for combining the standard content, templates and the custom content generated in a step 207, based on the input 205 from a subscriber through the device 110a, and forwarding the combined content to the publication mode 209 that based on input from the subscriber, determines the mode of publication, e-book or print-on-demand, via the terminal 110(b), or 3-D printing.

FIG. 4, consists, by way of example, of three columns, each having significance, insofar as the user, i.e., an individual, such a child or student, to matters delineating relatively unchanging variables. For discussion purposes these are labeled, a Record Of Key Parameters, 401, a Record Of a Key Life Objectives, 402, and a Record Of Key Life Skills, 403 (collectively “POS”). The lists contained in FIG. 4 are solely representative, as depending on the particular individual, embodiment of the invention, and actual variables used is a design choice. However, as illustrated, the category, 401, represents the fairly stable attributes of the individual for which the product is created. Category 402 represents the objective of the individual, such as might be indicted by a particular educational or vocational direction. Likewise, 403, represents a skill that an individual might wish to attain.

By way of illustration the variables, 401, 402, and 403, such as age, education, and skills, respectively, are stored in the user-specific database, referred to as the user-specific database 380, and used by the rules engine 180, in conjunction with the universe of related subject matter content database 370 and the library of content (e.g., templates and reference material) database 390, to create the media product that resides in the active products database 350, referred to as active projects, which ultimately produce the media products.

The variables referred to as Record Of Key Parameters, 401, Record Of Key Life Objectives, 402, and Record Of Key Life Skills, 403, are inputted at the start of project by the subscriber. The user of the terminal 110 through the reference device 110a, may change the variables at any time and thus affect the content of the active projects.

Although preferred embodiments include human-machine interface displays and applets that are capable of running in standard browsers, the invention may be practiced using native human machine interface applications that run directly under the host computers' operating systems (e.g., MICROSOFT® WINDOWS® operating system, UNIX® operating system, Apple® (a trademark of Apple, Inc.) operating system, LINUX® operating system and the like), as well as such devices as smartphones, IPad® device (an Apple trademark), and Android™ devices (a trademark of Goggle, LLC), and other personal assistant data devices.

Turning to FIG. 5, the invention allows the automatic updating and creation of a publication, multimedia or 3-D product via the architecture of a system 300. The system 300 includes a web crawler 320, which contains therein, a preselected list of URLs to visit, called seeds, within a subset of Internet websites, referred to as a Internet of relevant material 310. The crawler 320 functions and related search software may also provide the crawled content and associated metadata (such as URL of the content, type of page, time of crawl, and so forth). As the crawler visits these URLs, it identifies all the hyperlinks in a page and adds them to the list of URLs to visit, called the crawl frontier. URLs from the frontier are recursively visited according to a set of policies determined by the administrators of the system 100. As the crawler is archiving websites, it copies and saves the information as it proceeds. The archives are usually stored in a database, such as the database 370, in such a way that they can be viewed, read and navigated as if they were live on a website, or optionally viewed simply as static “snapshots.”

In one non limiting embodiment, the web crawler 320 seeks out one or more of the websites 310 having material generally relevant to one or more active projects, associated with one or more individuals, for the creation of the e-book, book and multimedia hereinbefore described and stored in the active projects database 350. Upon retrieving subject matter material, such as a document, from the Internet of relevant material 310, the system 300 stores the material into the universe of related subject matter content database 370. Thereafter the information in the database 370 applies a first test using a comparator 303, and a test 307 to compare and determine if the information in the database 370 is similar or the same as to the data stored in the database 380, to determine if the new information contains general points of relevance to the data stored in the database 380, as pertains to and described in connection with FIG. 4, the POS: 401, 402 and 403. Thus if there is a notable comparison from the comparator 303, then the test 307, utilizing a hardware logic circuit or software instruction, determines if the new information is specifically related to a project in the database 350, and if it is specifically related, the information from database 370 is used to update the project, by updating the database 350 information and the content in the active library information database 390, (See, FIG. 2, 201). If the information is not specifically related, comparator 303 reverts to a wait state upon receiving a signal from line 308, until it can compare subsequent information as retrieved by the crawler 320.

In an alternate embodiment, not illustrated in FIG. 5, the subject matter content database 370 is compared to both the active projects database 350 information and the library of information content database 390 information, to determine if the new retrieved matter, i.e., the subject matter content database 370 is relevant, before being tested or compared to the user specific database 380 information to determine if it needs to be included in an updated or derivative media.

One embodiment of the invention combines automatically machine-generated children's stories. Based on process 200, the user's attributes as contained in FIG. 4, and information residing in the databases, 350, 370, 380 and 380. DigiKid is a program that automatically generates children's stories, (See, http://bregman.dartmouth.edu/turingtests/Literary2018). A paradigmatic book, is “Alexander and the Terrible, Horrible, No Good, Very Bad Day.” https://www.amazon.com/gp/product/0689300727. An artificial intelligence algorithm, as employed in the present invention to both utilize the user's input and to nouns or noun phrases (e.g., “hat,” “car keys,” “wedding,” “sorrow,” “violin case,” brand or particular experience, e.g., visit to a zoo, sporting event or museum) that may be acquired through user prompting, produces at least one and virtually an unlimited number of original short stories. Artificial intelligence algorithms as incorporated herein are well-known to person having ordinary skill in the art of programming computer generated stories. However, the prior art products, artificial intelligence algorithms and programs do not combine aspects of the inventive system as disclosed herein, which generates stories specific to the user's attributes as contained in FIG. 4, process 200 and the rules 180, which further utilizes user input content 110a, and related information residing in the databases, 350, 370, 380 and 380.

Returning to the framework of the architecture and the system 100 and methodology as described with reference to FIGS. 2, 3, and 5, toys and other artifacts related to the production of e-book, book and multimedia, may be created, via 3-D printing, or manufactured by a third party and delivered to the subscriber, consistent with what an individual, such as the child may be reading about in a story plotline. In the embodiment of the system 100, the server 140 is in communication with the database 390 to store patterns, i.e., 3-D graphic representations of devices, such as toys and other artifacts and information related to managing such, based upon the provisions of an associated plan. The active projects stored in database 350, based on the foregoing, may also include 3-D representations of products that may be produced via computer aided manufacturing, or 3-D printing, as illustrated by reference to the manufacturing services 191 (FIG. 1).

With reference to FIG. 1 and FIG. 6, one embodiment of the invention is an architecture for creating a e-book 410 or book 410 or a multimedia presentation 411, including one or more storage devices containing databases associated thereto, including the user specific database 380; the active projects database 350; the library of content information database 390; the related content database 370; the web crawler 320 to search and to store new information into the related content database 370; a first processor 420 for determining if the new information, based on data in the user specific database 380, updates the active projects database 350; the manager tool processor 430 to load media content for updating the active projects database 350; a media processor 440 having a plurality of tools to assemble, display the media, a second processor 450 and related GUI interface 460 for the user to create a 2-D picture of a childlike character from one of (a) the photograph of the user's face, (b) the computer generated representation of the user's face, (c) the menu of choices, wherein one or more character choices are based on features and attributes of the user, and an interface 470 to automatically install the picture of the childlike character into a storyline, said storyline having one or more of a plot, scene, music, voiceover, and one or more characters and related vocalizations.

With reference to the foregoing descriptions related to FIGS. 1, 2, 3, 4, 5 and 6, one embodiment of the invention is a method for creating an e-book, book, multimedia presentations or 3-D printed products, via the network 120 (FIG. 1) and architecture shown in FIG. 5 and FIG. 6, including the steps of: accessing one or more user computers in a network for purposes of obtaining input from a user via the terminal device 110, and other relevant related content via the crawler 320, and storing the content in the library of content 390 and the universe of related subject matter content 370, respectively; loading the media application having a plurality of tools into the one or more user computers, such as the server 140 and the terminal 111; using the manager tool processor 430 (see, FIG. 6) from the media application to load various media content related to active projects into the database 350; obtaining input from the user via terminal device 110 information, as it relates to the individual for whom the e-book, book, multimedia or 3-D product will benefit, by way of example and not limitation, a likeness of the user's image, age, environment, demographic, cultural base, life change events, current events; providing templates for the create of pages with specific layouts; determining if a revision of the active projects is necessitated by new information; assembling the media data having new information into one or more of text documents, graphic images, multimedia images, audio or data files or 3-D printer files; providing plug-ins for each type content that may be required to display the content on various devices, such as computers, smartphones or PDAs (e.g., IPad); providing converters for displaying the e-book, book or multimedia in a graphical user interface; and updating the e-book, book, multimedia or 3-D printer content, by searching additional resource information; permitting collaboration among other users, such as among other children or their parents, teachers or mentors, and providing automatic active project updating using searched resource information, obtained from the crawler or other Internet search services.

While the foregoing invention has been described with reference to the above embodiments, additional modifications and changes can be made without departing from the spirit of the invention.

I claim:

1. A computer system for creating one of a book, e-book, multimedia presentation or a 3-D printed product, comprising: one or more storage devices containing databases associated thereto, including a user specific database; an active projects database; a library of content information database; a related content database; a web search engine to search and store new information into the related content database; a first processor for determining if the new information, based on data in the user specific database, updates the active projects database; a manager tool processor to load media content for updating the active projects database; a media processor having a plurality of tools to assemble, and display the book, e-book, or multimedia presentation, 3-D printed product; a second processor and related GUI interface for a user to create a 2-D digital image or avatar of a childlike character from optionally: (a) one of a photograph image of the user's face, or (b) a computer generated representation of the user's face based on a menu of choices, wherein one or more character choices are based on features and attributes of the user; and an interface to automatically install the image or avatar of the childlike character into a storyline, having one or more of a plot, scene, theme, music, voiceover, one or more characters, and related vocalizations: optionally (1) authored by the user, or (2) automatically computer generated, using a program that processes key words to create the storyline.

2. The computer system in claim 1, wherein the one or more characters are based on a user's age and phenotypical characteristics, such as one or more of a face size, shape, hair color, texture, body shape, complexion, to create a digital image or avatar of a childlike character.

3. The computer system in claim 1, wherein the user's digital image or avatar is modified by the user to reflect changes in the user's physical appearance or is dynamically modified as images of the user are available within the user specific database or on the network.

4. The computer system in claim 1, wherein the form of a repeatable series of the book, e-book, multimedia presentation or a 3-D printed product is prefaced with a title “My Day At ______x______” wherein the “______x______” or other such titles, to represent one or more of a brand name or name of the child's experience.

5. The computer system in claim 3, wherein a first menu of choices displays a subset of the childlike character stored in the image database.

6. The computer system in claim 3 further includes a detector that utilizes one of a camera or video capture device, for obtaining a digital image of the face of the childlike character and storing said image into the image database.

7. The computer system in claim 1, wherein the one or more characters are computer generated through the use of one or more facial recognition software that image the user, or a photo of the user to create a digital image of the user.

8. The computer system in claim 1, wherein the one or more articles of clothing of the one or more characters are selected by the user from a second menu of choices.

9. The computer system in claim 1, wherein one or more characters are assembled into one of an e-book printed book or multimedia presentation.

10. The computer system in claim 1, wherein the multimedia presentation includes one or more games based on the storyline.

11. The computer system in claim 1, further includes 3D virtual elements of (a) a customizable feature of the character(s) and (b) a choice of one or more of a storyline, art, text, music, and vocalizations to appear in a projection of virtual images onto a wearer's visual field, such as the retina, thus conveying virtual animations and objects to provide an augmented sense of 3-D.

12. The computer system in claim 1, wherein the web search engine visits one or more websites having subject matter material relevant to one or more active projects associated with one or more users.

13. The computer system in claim 1, wherein the computer system includes a comparator to compare the retrieved subject matter to the information in the active products database.

14. The computer system in claim 12, wherein the computer system includes one of a logic circuit or software instruction to determine if the subject matter is related to information in the active products project in a database.

15. The computer system in claim 1, wherein the web search engine provides retrieved subject matter relevant to the storyline and stores the subject matter into a database.

16. A computer method for creating one of a book, e-book, multimedia presentation or 3-D printed product, comprising the steps of: storing user specific data in a first database; storing a library of content information in a second database; searching and acquiring additional resource information and storing the resource information into a related information database; determining if the information in the related information database, based on the data in the first database, requires updating an active projects database; updating the active projects database assembling an active project based on the data in the active projects database into one or more of a book, e-book, multimedia presentation, interfacing a user application for creating one or more computer generated characters of the book, e-book or multimedia presentation, said characters based on attributes of the user; and automatically installing the one or more characters into a storyline, said storyline, optionally generated by the user or automatically, having one or more of a plot, scene, music, voiceover, one or more characters, and related vocalizations.

17. The method of claim 16, further including automatically updating active projects from the web search engine information content.

18. The method of claim 16, electronically including discussion questions by automatically adding to the active projects database.

19. The method of claim 16 further includes applying one or more rules and inputs from a subscriber and combining the standard content, library content, and custom content into one of the e-book, book or multimedia presentation.

20. A non-transitory computer-readable medium for execution by a processor comprising code for: (a) creating one of a book, e-book multimedia presentation; (b) storing user specific data in a first database; storing content related to the user specific data in a second database; (c) storing a library of content information in a third database; (c) loading a media application having a plurality of tools into one or more computers; (d) using a manager tool processor from the media application to load media content for creating an active products into an active projects database from user specific data and library of content information; (e) updating content of one of the book, e-book multimedia presentation by searching additional resource information; (f) assembling the active projects into one or more of the e-book, book, multimedia presentation; (g) interfacing a user application for creating one or more computer generated characters of the e-book, book or multimedia presentation, said characters based on attributes of the user, and automatically installing the one or more characters into a storyline, said storyline, optionally generated by the user or automatically, having one or more of a plot, scene, music, voiceover, one or more characters, and related vocalizations.
